(19) United States
(12) Patent Application Publication
(10) Pub. No.: US 2013/0033245 A1
(43) Pub. Date: Feb. 7, 2013

(54) BANDGAP CIRCUIT FOR PROVIDING STABLE REFERENCE VOLTAGE

(71) Applicant: KianTiong Wong, Johor (MY)

(72) Inventor: KianTiong Wong, Johor (MY)

(73) Assignee: MEDIATEK SINGAPORE PTE. LTD., Singapore (SG)

(21) Appl. No.: 13/273,565

(22) Filed: Oct. 14, 2011

Related U.S. Application Data
(60) Provisional application No. 61/514,978, filed on Aug. 4, 2011.

(51) Int. Cl. G05F 1/46

(52) U.S. Cl. 323/281

(57) ABSTRACT

The invention provides a bandgap circuit for providing stable reference voltages. The bandgap circuit comprises a core circuit and an output branch. The core circuit comprises: a first transistor, coupled between a supplied working voltage and a first node, and having a gate coupled to the first node; a second transistor, coupled between the supplied working voltage and a second node, and having a gate coupled to the first node; a third transistor, coupled between the first node and a ground voltage, and having a gate coupled to a third node; a fourth transistor, coupled between the third node and the ground voltage, and having a gate coupled to the second node; and a first resistor, coupled between the second and third nodes. The output branch is coupled to the core circuit to receive an output of the core circuit, and arranged to output a reference voltage at an output node.

### CROSS REFERENCE TO RELATED APPLICATIONS

This application claims the benefit of U.S. Provisional Application No. 61/514,978, filed on Aug. 4, 2011, the entirety of which is incorporated by reference herein.

### BACKGROUND OF THE INVENTION

1. Field of the Invention

The disclosure generally relates to a bandgap circuit, and more particularly, relates to a bandgap circuit for providing stable reference voltages.

2. Description of the Related Art

A bandgap circuit is widely used as a power supply circuit capable of generating voltage or current constantly without being affected by power supply voltage fluctuation or temperature fluctuation in generating a reference voltage in a semiconductor device.

It is very difficult for traditional bandgap circuits to reduce noise effectively unless they have a large area. Consequently, there is a need for a new bandgap circuit design with good noise performance and small area.

### BRIEF SUMMARY OF THE INVENTION

In one exemplary embodiment, the disclosure is directed to a bandgap circuit for providing stable reference voltages, comprising: a core circuit, comprising: a first transistor, coupled between a supplied working voltage and a first node, and having a gate coupled to the first node; a second transistor, coupled between the supplied working voltage and a second node, and having a gate coupled to the first node; a third transistor, coupled between the first node and a ground voltage, and having a gate coupled to a third node; a fourth transistor, coupled between the third node and the ground voltage, and having a gate coupled to the second node; and a first resistor, coupled between the second and third nodes; and an output branch, coupled to the core circuit to receive an output of the core circuit, and arranged to output a reference voltage at an output node.

### BRIEF DESCRIPTION OF DRAWINGS

The invention can be more fully understood by reading the subsequent detailed description and examples with references made to the accompanying drawings, wherein:

FIG. 1 is a diagram for illustrating a bandgap circuit according to an embodiment of the invention;

FIG. 2 is a circuit diagram for illustrating a bandgap circuit according to an embodiment of the invention;

FIG. 3A is a circuit diagram for illustrating the noise cancellation technique according to an embodiment of the invention;

FIG. 3B is a circuit diagram for DC (Direct Current) analysis of the bandgap circuit according to an embodiment of the invention;

FIG. 4 is a circuit diagram for illustrating a bandgap circuit according to another embodiment of the invention;

FIG. 5 is a circuit diagram for DC analysis of the bandgap circuit according to an embodiment of the invention;

FIG. 6 is a DC response diagram of the bandgap circuit according to an embodiment of the invention; and

FIG. 7 is another DC response diagram of the bandgap circuit according to the embodiment of the invention.

### DETAILED DESCRIPTION OF THE INVENTION

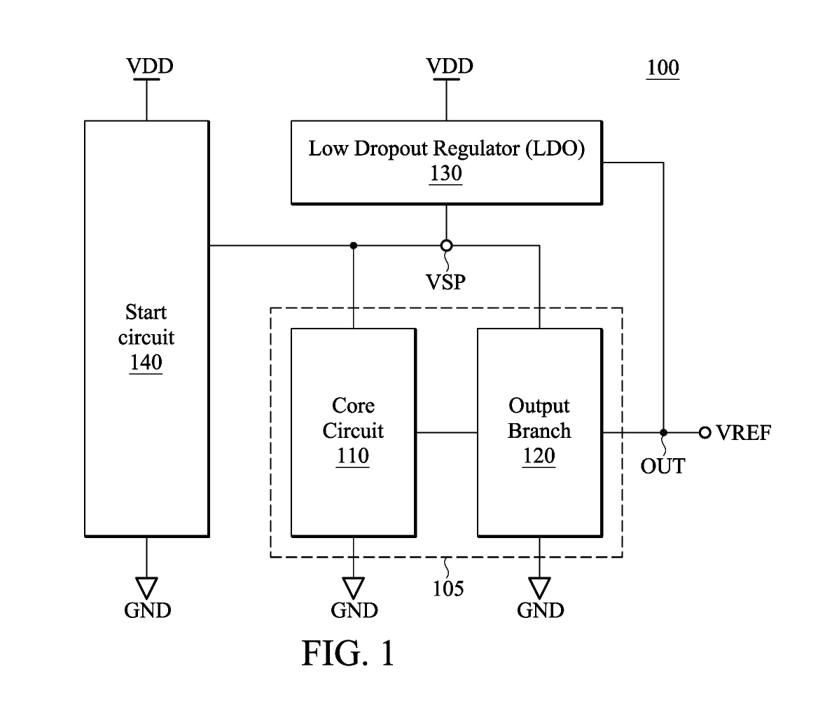

FIG. 1 is a diagram for illustrating a bandgap circuit 100 according to an embodiment of the invention. As shown in FIG. 1, the bandgap circuit 100 comprises: a main circuit 105, a low dropout regulator (LDO) 130, and a startup circuit 140. A power supply voltage VDD (e.g., 1.8V) and a ground voltage GND (e.g., 0V) are provided. The main circuit 105 is the essential part of the bandgap circuit 100, and comprises a core circuit 110 and an output branch 120. The output branch 120 is coupled to the core circuit 110 so as to receive an output of the core circuit 110, and configured to output a reference voltage VREF at an output node OUT. The LDO 130 is configured to convert the power supply voltage VDD of the bandgap circuit 100 into a supplied working voltage VSP, wherein the reference voltage VREF is fed to the LDO 130. The LDO 130 is utilized for rejecting noise from the power supply voltage VDD and for providing the step-up or step-down supplied working voltage VSP. The startup circuit 140 is coupled to the core circuit 110 and configured to initiate the core circuit 110. It is noted that the LDO 130 and the startup circuit 140 may be removed in other embodiments of the invention.

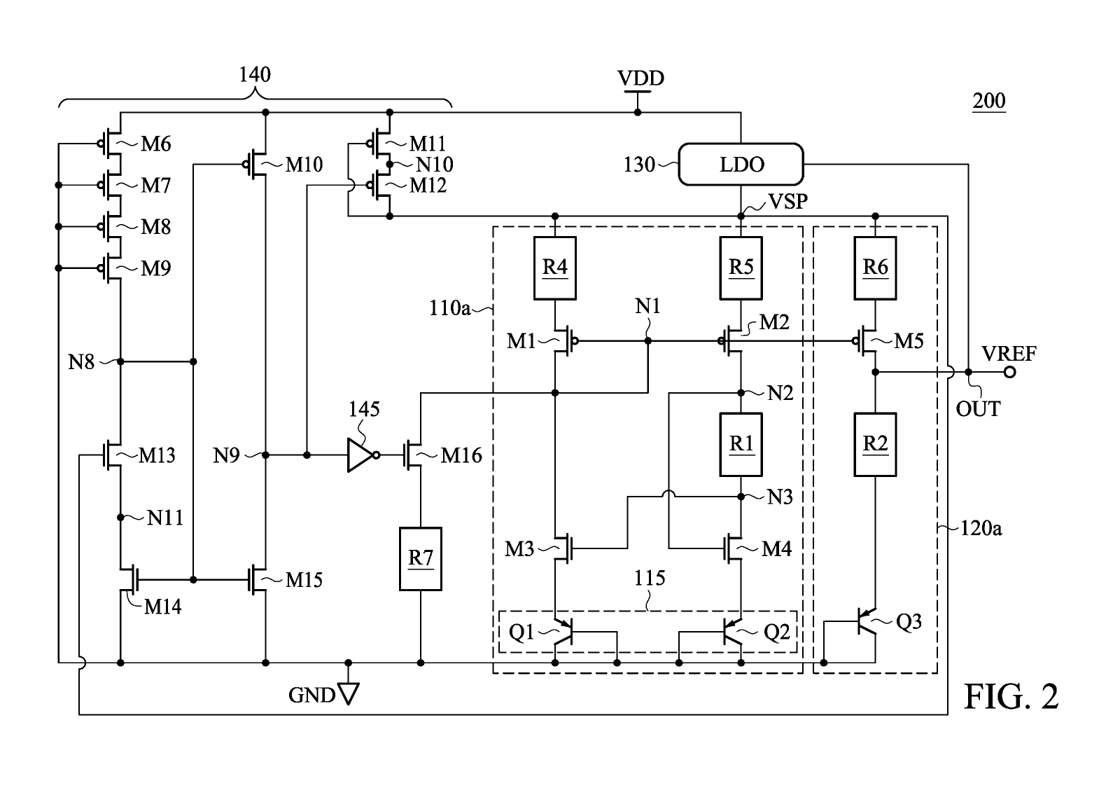

FIG. 2 is a circuit diagram for illustrating a bandgap circuit 200 according to an embodiment of the invention. As shown in FIG. 2, the bandgap circuit 200 comprises: a core circuit 110a, an output branch 120a, an LDO 130, and a startup circuit 140.

The core circuit 110a may comprise: transistors M1, M2, M3 and M4, resistors R1, R4 and R5, and a BJT (bipolar junction transistors) component 115. The transistors M1 and M2 may be PMOS transistors (P-channel Metal-Oxide-Semiconductor Field-Effect Transistor), and the transistors M3 and M4 are NMOS transistors (N-channel Metal-Oxide-Semiconductor Field-Effect Transistor). The transistor M1 is coupled between the supplied working voltage VSP and a node N1, and has a gate coupled to the node N1. The transistor M2 is coupled between the supplied working voltage VSP and a node N2, and has a gate coupled to the node N1. The transistor M3 is coupled between the node N1 and the BJT component 115, and has a gate coupled to a node N3. The transistor M4 is coupled between the node N3 and the BJT component 115, and has a gate coupled to the node N2. The BJT component 115 comprises bipolar junction transistors (BJT) Q1 and Q2, wherein the BJT Q1 is coupled between the transistor M3 and the ground voltage GND, and has a base coupled to the ground voltage GND, and the BJT Q2 is coupled between the transistor M4 and the ground voltage GND, and has a base coupled to the ground voltage GND. The resistor R1 is coupled between the node N2 and the node N3. It is noted that the size ratio of the transistor M3 to the transistor M4 is different from the size ratio of the BJT Q1 to the BJT Q2. In some embodiments, the size ratio of the transistor M3 to the transistor M4 is 3:2, and the size ratio of the BJT Q1 to the BJT Q2 is 8:1. The resistor R4 is coupled between the supplied working voltage VSP and the transistor M1, and the resistor R5 is coupled between the supplied working voltage VSP and the transistor M2. It is noted that the resistors R4 and R5 may be removed in other embodiments of the invention.

The output branch 120a may comprise: a transistor M5, a BJT Q3, and resistors R2 and R6. The transistor M5 may be a PMOS transistor (P-channel Metal-Oxide-Semiconductor Field-Effect Transistor). The transistor M5 is coupled between the output node OUT and the supplied working voltage VSP, and has a gate coupled to the node N1. The resistor R2 is coupled between the output node OUT and the BJT Q3. The BJT Q3 is coupled between resistor R2 and the ground voltage GND, and has a base coupled to the ground voltage GND. The resistor R6 is coupled between the transistor M5 and the supplied working voltage VSP. It is noted that the resistor R6 may be removed in other embodiments of the invention. There may be a plurality of output branches coupled to the core circuit 110a so as to output a plurality of reference voltages.

The startup circuit 140 may comprise: transistors M6, M7, M8, M9, M10, M11, M12, M13, M14, M15 and M16, an inverter 145, and a resistor R7. The transistors M6, M7, M8, M9, M10, M11 and M12 may be PMOS transistors (P-channel Metal-Oxide-Semiconductor Field-Effect Transistor), and the transistors M13, M14, M15 and M16 are NMOS transistors (N-channel Metal-Oxide-Semiconductor Field-Effect Transistor). Each of the transistors M6, M7, M8 and M9 is coupled between the power supply voltage VDD and a node N8, and has a gate coupled to the ground voltage GND. The transistor M10 is coupled between the power supply voltage VDD and a node N9, and has a gate coupled to the node N8. The transistor M11 is coupled between the power supply voltage VDD and a node N10, and has a gate coupled to the supplied working voltage VSP. The transistor M12 is coupled between the node N10 and the supplied working voltage VSP, and has a gate coupled to the node N9. The transistor M13 is coupled between the node N8 and a node N11, and has a gate coupled to the supplied working voltage VSP. The transistor M14 is coupled between the node N11 and the ground voltage GND, and has a gate coupled to the node N8. The transistor M15 is coupled between the node N9 and the ground voltage GND, and has a gate coupled to the node N8. The transistor M16 is coupled between the node N1 and the resistor R7. The inverter 145 is coupled between the node N9 and a gate of the transistor M16. The resistor R7 is coupled between the transistor M16 and the ground voltage GND. The startup circuit 140 is configured to initiate the core circuit 110a. It merely works during the initial process. Therefore, the startup circuit 140 may be removed in some embodiments.

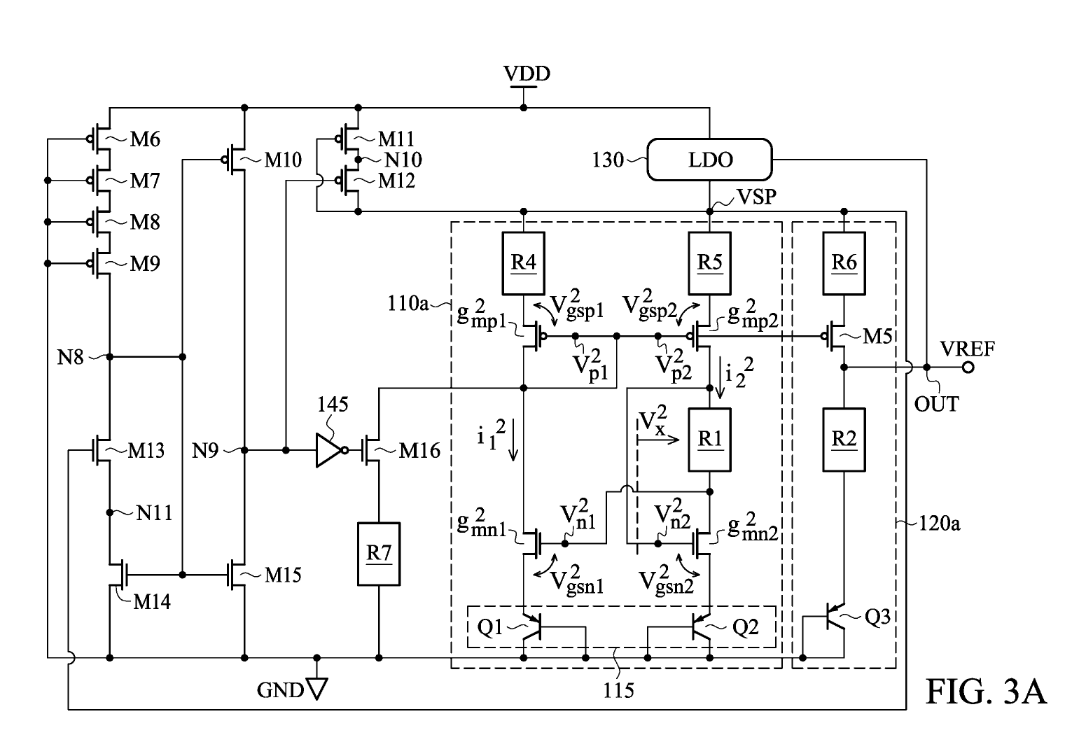

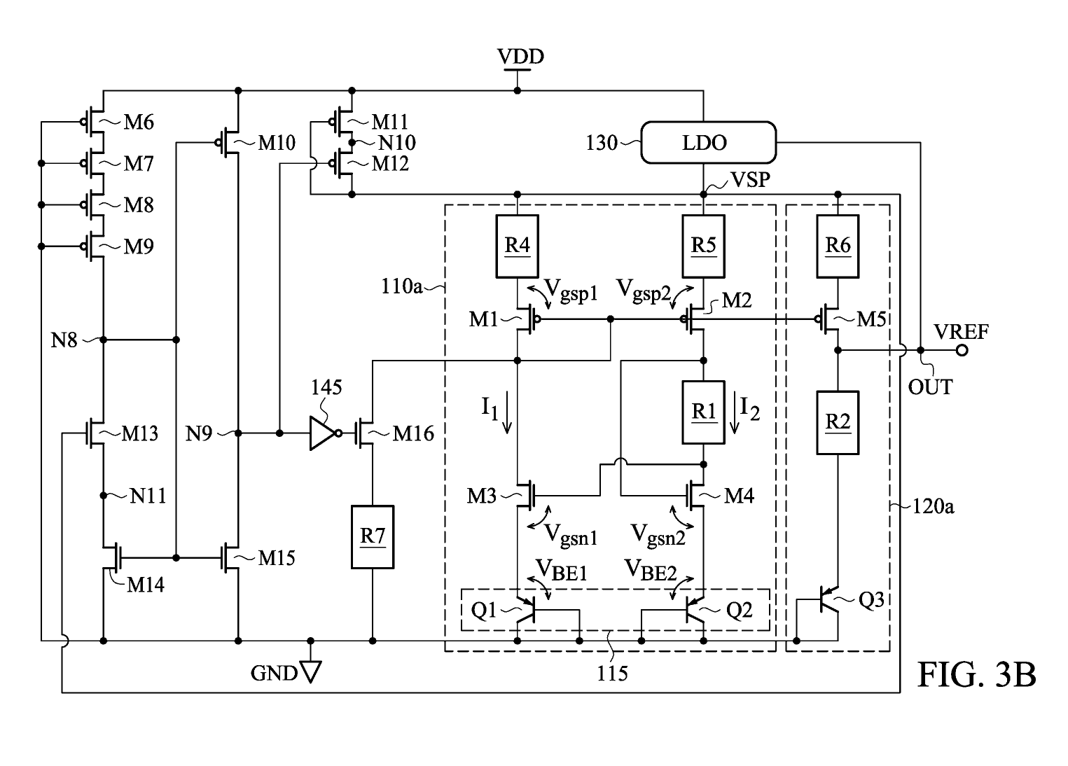

The bandgap circuit 200 is designed to have noise cancellation so as to provide the stable reference voltage VREF. FIG. 3A is a circuit diagram for illustrating a noise cancellation technique according to an embodiment of the invention. The noise generated by the transistors M1, M2, M3 and M4 is modeled as noise sources Vₚ₁², Vₚ₂², Vₙ₁² and Vₙ₂², respectively. In a small signal model, the bandgap circuit 200 is analyzed as follows:

$$\begin{matrix}{V}_{gsn 2}^{2} = \frac{{i}_{2}^{2}}{{g}_{mn 2}^{2}} & ( 1 ) \\ {i}_{2}^{2} = {g}_{mp 2}^{2} {V}_{gsp 2}^{2} & ( 2 ) \\ {V}_{x}^{2} = {V}_{gsn 2}^{2} + {V}_{n 2}^{2} + {i}_{2}^{2} {R}_{1}^{2} = ( \frac{1}{{g}_{mn 2}^{2}} + {R}_{1}^{2} ) {i}_{2}^{2} + {V}_{n 2}^{2} & ( 3 ) \\ {i}_{1}^{2} = {g}_{mn 1}^{2} {V}_{gsn 1}^{2} & ( 4 ) \\ {V}_{gsn 1}^{2} = {V}_{x}^{2} + {V}_{n 1}^{2} & ( 5 ) \\ {V}_{gsp 1}^{2} = \frac{{i}_{1}^{2}}{{g}_{mp 1}^{2}} & ( 6 ) \\ {V}_{gsp 2}^{2} = {V}_{p 1}^{2} + {V}_{gsp 1}^{2} + {V}_{p 2}^{2} , & ( 7 )\end{matrix}$$

wherein:

V_{gsp1} is the voltage difference between the gate and the source of the transistor M1;

V_{gsp2} is the voltage difference between the gate and the source of the transistor M2;

V_{gsn1} is the voltage difference between the gate and the source of the transistor M3;

V_{gsn2} is the voltage difference between the gate and the source of the transistor M4;

gₘₚ₁ is the transconductance of the transistor M1;

gₘₚ₂ is the transconductance of the transistor M2;

gₘₙ₁ is the transconductance of the transistor M3;

gₘₙ₂ is the transconductance of the transistor M4;

i₁ is the current flowing through the transistors M1 and M3;

i₂ is the current flowing through the transistors M2 and M4;

Rₗ is resistance of the resistor R1; and

Vₓ is a noise indicator.

In accordance with the equation (3), the noise indicator Vₓ can be analyzed as follows:

$$\begin{matrix}\begin{matrix}{V}_{x}^{2} = ( \frac{1}{{g}_{mn 2}^{2}} + {R}_{1}^{2} ) {i}_{2}^{2} + {V}_{n 2}^{2} \\ = ( \frac{1}{{g}_{mn 2}^{2}} + {R}_{1}^{2} ) {g}_{mp 2}^{2} {V}_{gsp 2}^{2} + {V}_{n 2}^{2} \\ = ( \frac{1}{{g}_{mn 2}^{2}} + {R}_{1}^{2} ) {g}_{mp 2}^{2} ( {V}_{p 1}^{2} + {V}_{p 2}^{2} + {V}_{gsp 1}^{2} ) + {V}_{n 2}^{2} \\ = ( \frac{1}{{g}_{mn 2}^{2}} + {R}_{1}^{2} ) {g}_{mp 2}^{2} ( {V}_{p 1}^{2} + {V}_{p 2}^{2} + \frac{{i}_{1}^{2}}{{g}_{mp 1}^{2}} ) + {V}_{n 2}^{2} \\ = ( \frac{1}{{g}_{mn 2}^{2}} + {R}_{1}^{2} ) {g}_{mp 2}^{2} ( {V}_{p 1}^{2} + {V}_{p 2}^{2} + \frac{{g}_{mn 1}^{2} {V}_{gsn 1}^{2}}{{g}_{mp 1}^{2}} ) + {V}_{n 2}^{2} \\ = ( \frac{1}{{g}_{mn 2}^{2}} + {R}_{1}^{2} ) {g}_{mp 2}^{2} ( {V}_{p 1}^{2} + {V}_{p 2}^{2} + \frac{{g}_{mn 1}^{2} ( {V}_{x}^{2} + {V}_{n 1}^{2} )}{{g}_{mp 1}^{2}} ) + {V}_{n 2}^{2}\end{matrix} & ( 8 ) \\ \begin{matrix}{V}_{x}^{2} = \frac{( {V}_{p 1}^{2} + {V}_{p 2}^{2} + \frac{{g}_{mn 1}^{2}}{{g}_{mp 1}^{2}} {V}_{n 1}^{2} ) ( \frac{1}{{g}_{mn 2}^{2}} + {R}_{1}^{2} ) {g}_{mp 2}^{2} + {V}_{n 2}^{2}}{1 - \frac{{g}_{mn 1}^{2} {g}_{mp 2}^{2}}{{g}_{mp 1}^{2}} ( \frac{1}{{g}_{mn 2}^{2}} + {R}_{1}^{2} )} \\ = \frac{( {V}_{p 1}^{2} + {V}_{p 2}^{2} ) ( \frac{1}{{g}_{mn 2}^{2}} + {R}_{1}^{2} ) {g}_{mp 2}^{2} + {V}_{n 2}^{2}}{1 - \frac{{g}_{mn 1}^{2} {g}_{mp 2}^{2}}{{g}_{mp 1}^{2}} ( \frac{1}{{g}_{mn 2}^{2}} + {R}_{1}^{2} )} + \\ \frac{\frac{{g}_{mn 1}^{2} {g}_{mp 2}^{2}}{{g}_{mp 1}^{2}} ( \frac{1}{{g}_{mn 2}^{2}} + {R}_{1}^{2} ) {V}_{n 1}^{2}}{1 - \frac{{g}_{mn 1}^{2} {g}_{mp 2}^{2}}{{g}_{mp 1}^{2}} ( \frac{1}{{g}_{mn 2}^{2}} + {R}_{1}^{2} )}\end{matrix} & ( 9 ) \\ {V}_{x}^{2} ∝ - α {V}_{n 1}^{2} & ( 10 ) \\ {V}_{gsn 1}^{2} = {V}_{n 1}^{2} + {V}_{x}^{2} ∝ - β {V}_{n 1}^{2} , & ( 11 )\end{matrix}$$

wherein:

α is a positive constant (in one embodiment, 1<α<2); and

β is a positive constant (in one embodiment, 0<β<1).

To sum up, the square of the noise indicator Vₓ is in direct proportion to the product of a negative constant, −α, and the noise source Vₙ₁², and the square of the voltage difference V_{gsn1} is in direct proportion to the product of a negative constant, −β, and the noise source Vₙ₁². Therefore, it is clear that the bandgap circuit 200 with the noise cancellation technique can reduce the impact of noise effectively.

FIG. 3B is a circuit diagram for DC (Direct Current) analysis of the bandgap circuit 200 according to an embodiment of the invention. The DC behavior of the bandgap circuit 200 is analyzed as follows:

$$\begin{matrix}{V}_{BE 2} + {V}_{gsn 2} - ( {V}_{BE 1} + {V}_{gsn 1} ) = {IR}_{1} & ( 12 ) \\ {IR}_{1} = {V}_{BE 2} - {V}_{BE 1} + {V}_{gsn 2} - {V}_{gsn 1} = Δ {V}_{BE} + Δ {V}_{gsn} & ( 13 ) \\ I = \frac{Δ {V}_{BE} + Δ {V}_{gsn}}{{R}_{1}} ( Assume Δ {V}_{BE} > 0 , Δ {V}_{gsn} > 0 and {I}_{1} = {I}_{2} = I ) & ( 14 ) \\ I = \frac{Δ {V}_{BE} + \sqrt{\frac{2 I}{{μ}_{n} {{C}_{ox} ( \frac{W}{L} )}_{n 2}}} ( 1 - \sqrt{\frac{1}{N}} ) + ( {V}_{thn 2} - {V}_{thn 1} )}{{R}_{1}} & ( 15 ) \\ \frac{{IR}_{1} - Δ {V}_{BE} - Δ {V}_{thn}}{( 1 - \sqrt{\frac{1}{N}} )} = \sqrt{\frac{2 I}{{μ}_{n} {{C}_{ox} ( \frac{W}{L} )}_{n 2}}} & ( 16 ) \\ \frac{{[ {IR}_{1} - ( Δ {V}_{BE} + Δ {V}_{thn} ) ]}^{2}}{{( 1 - \sqrt{\frac{1}{N}} )}^{2}} = \frac{2 I}{{μ}_{n} {{C}_{ox} ( \frac{W}{L} )}_{n 2}} & ( 17 ) \\ {R}_{1}^{2} {μ}_{n} {{C}_{ox} ( \frac{W}{L} )}_{n 2} {I}^{2} - [ \begin{matrix}2 {R}_{1} ( Δ {V}_{BE} + Δ {V}_{thn} ) {μ}_{n} {{C}_{ox} ( \frac{W}{L} )}_{n 2} + \\ 2 {( 1 - \sqrt{\frac{1}{N}} )}^{2}\end{matrix} ] I + {μ}_{n} {{C}_{ox} ( \frac{W}{L} )}_{n 2} {( Δ {V}_{BE} + Δ {V}_{thn} )}^{2} = 0 & ( 18 ) \\ I = \frac{\begin{matrix}2 {R}_{1} ( Δ {V}_{BE} + Δ {V}_{thn} ) {μ}_{n} {{C}_{ox} ( \frac{W}{L} )}_{n 2} + \\ 2 {( 1 - \sqrt{\frac{1}{N}} )}^{2} \pm \sqrt{{b}^{2} - 4 ac}\end{matrix}}{2 {R}_{1}^{2} {μ}_{n} {{C}_{ox} ( \frac{W}{L} )}_{n 2}} & ( 19 ) \\ \begin{matrix}{b}^{2} - 4 ac = {[ 2 {R}_{1} ( Δ {V}_{BE} + Δ {V}_{thn} ) {μ}_{n} {{C}_{ox} ( \frac{W}{L} )}_{n 2} + 2 {( 1 - \sqrt{\frac{1}{N}} )}^{2} ]}^{2} - \\ 4 {{R}_{1}^{2} ( {μ}_{n} {{C}_{ox} ( \frac{W}{L} )}_{n 2} )}^{2} {( Δ {V}_{BE} + Δ {V}_{thn} )}^{2} \\ = 2 {( 1 - \sqrt{\frac{1}{N}} )}^{2} [ \begin{matrix}4 {R}_{1} ( Δ {V}_{BE} + Δ {V}_{thn} ) {μ}_{n} {{C}_{ox} ( \frac{W}{L} )}_{n 2} + \\ 2 {( 1 - \sqrt{\frac{1}{N}} )}^{2}\end{matrix} ]\end{matrix} & ( 20 ) \\ I = \frac{\begin{matrix}{R}_{1} ( Δ {V}_{BE} + Δ {V}_{thn} ) {μ}_{n} {{C}_{ox} ( \frac{W}{L} )}_{n 2} + {( 1 - \sqrt{\frac{1}{N}} )}^{2} \pm \\ ( 1 - \sqrt{\frac{1}{N}} ) \sqrt{[ 2 {R}_{1} ( Δ {V}_{BE} + Δ {V}_{thn} ) {μ}_{n} {{C}_{ox} ( \frac{W}{L} )}_{n 2} + {( 1 - \sqrt{\frac{1}{N}} )}^{2} ]}\end{matrix}}{{R}_{1}^{2} {μ}_{n} {{C}_{ox} ( \frac{W}{L} )}_{2}} & ( 21 ) \\ I = \frac{\begin{matrix}{R}_{1} ( Δ {V}_{BE} + Δ {V}_{thn} ) {μ}_{n} {{C}_{ox} ( \frac{W}{L} )}_{n 2} + {( 1 - \sqrt{\frac{1}{N}} )}^{2} - \\ ( 1 - \sqrt{\frac{1}{N}} ) \sqrt{[ 2 {R}_{1} ( Δ {V}_{BE} + Δ {V}_{thn} ) {μ}_{n} {{C}_{ox} ( \frac{W}{L} )}_{n 2} + {( 1 - \sqrt{\frac{1}{N}} )}^{2} ]}\end{matrix}}{{R}_{1}^{2} {μ}_{n} {{C}_{ox} ( \frac{W}{L} )}_{n 2}} & ( 22 ) \\ I = \frac{\begin{matrix}{R}_{1} ( Δ {V}_{BE} + Δ {V}_{thn} ) {μ}_{n} {{C}_{ox} ( \frac{W}{L} )}_{n 2} + {( 1 - \sqrt{\frac{1}{N}} )}^{2} + \\ ( 1 - \sqrt{\frac{1}{N}} ) \sqrt{[ 2 {R}_{1} ( Δ {V}_{BE} + Δ {V}_{thn} ) {μ}_{n} {{C}_{ox} ( \frac{W}{L} )}_{n 2} + {( 1 - \sqrt{\frac{1}{N}} )}^{2} ]}\end{matrix}}{{R}_{1}^{2} {μ}_{n} {{C}_{ox} ( \frac{W}{L} )}_{n 2}} & ( 23 ) \\ I = \frac{( Δ {V}_{BE} + Δ {V}_{thn} )}{{R}_{1}} + \frac{{( 1 - \sqrt{\frac{1}{N}} )}^{2}}{{R}_{1}^{2} {μ}_{n} {{C}_{ox} ( \frac{W}{L} )}_{n 2}} + \frac{( 1 - \sqrt{\frac{1}{N}} ) \sqrt{[ \begin{matrix}2 {R}_{1} ( Δ {V}_{BE} + Δ {V}_{thn} ) {μ}_{n} {{C}_{ox} ( \frac{W}{L} )}_{n 2} + \\ {( 1 - \sqrt{\frac{1}{N}} )}^{2}\end{matrix} ]}}{{R}_{1}^{2} {μ}_{n} {{C}_{ox} ( \frac{W}{L} )}_{n 2}} , & ( 25 )\end{matrix}$$

wherein:

V_{BE1} is the voltage difference between the base and the emitter of the BJT Q1;

V_{BE2} is the voltage difference between the base and the emitter of the BJT Q2;

ΔV_{BE} is the difference between V_{BE1} and V_{BE2};

I₁ is the direct current flowing through the transistor M1 and M3;

I₂ is the direct current flowing through the transistor M2 and M4;

V_{gsp1} is the voltage difference between the gate and the source of the transistor M1;

V_{gsp2} is the voltage difference between the gate and the source of the transistor M2;

V_{gsn1} is the voltage difference between the gate and the source of the transistor M3;

V_{gsn2} is the voltage difference between the gate and the source of the transistor M4;

ΔV_{gsn} is the difference between V_{gsn1} and V_{gsn2};

Vₜₕₙ₁ is the threshold voltage of the transistor M3;

Vₜₕₙ₂ is the threshold voltage of the transistor M4;

ΔVₜₕₙ is the difference between Vₜₕₙ₁ and Vₜₕₙ₂;

μₙ is electron mobility in NMOS transistors;

Cₒₓ is the capacitance per unit gate area of the oxide layer;

R₁ is resistance of the resistor R1;

$${( \frac{W}{L} )}_{n 2}$$

is the ratio of channel width to channel length of the transistor M4; and

N is the size ratio of the transistor M3 to the transistor M4.

It is noted that the equation (21) has two possibilities, the equation (22) and the equation (23); since in the equation (22) ΔV_{gsn} is equal to (IR₁−ΔV_{BE}) that is a negative value causing a negative ΔV_{gs}, the equation (22) is unreasonable. The reasonable result is the equation (23). In accordance with the equation (25), the current I (i.e., I₂, the current flowing through the transistors M2 and M4) is the sum of three portions, that is, a PTAT (Proportional To Absolute Temperature) current

$$\frac{( Δ {V}_{BE} + Δ {V}_{thn} )}{{R}_{1}} ,$$

a constant transconductance (Gₘ) current

$$\frac{{( 1 - \sqrt{\frac{1}{N}} )}^{2}}{{R}_{1}^{2} {μ}_{n} {{C}_{ox} ( \frac{W}{L} )}_{n 2}} ,$$

and a mixing current

$$\frac{( 1 - \sqrt{\frac{1}{N}} ) \sqrt{[ 2 {R}_{1} ( Δ {V}_{BE} + Δ {V}_{thn} ) {μ}_{n} {{C}_{ox} ( \frac{W}{L} )}_{n 2} + {( 1 - \sqrt{\frac{1}{N}} )}^{2} ]}}{{R}_{1}^{2} {μ}_{n} {{C}_{ox} ( \frac{W}{L} )}_{n 2}} .$$

In one embodiment, the PTAT current is equal to 35.888 μA, the constant transconductance current is equal to 1.593 μA, and the mixing current is equal to 10.899 μA. In other words, the PTAT current is the dominant component of the current I.

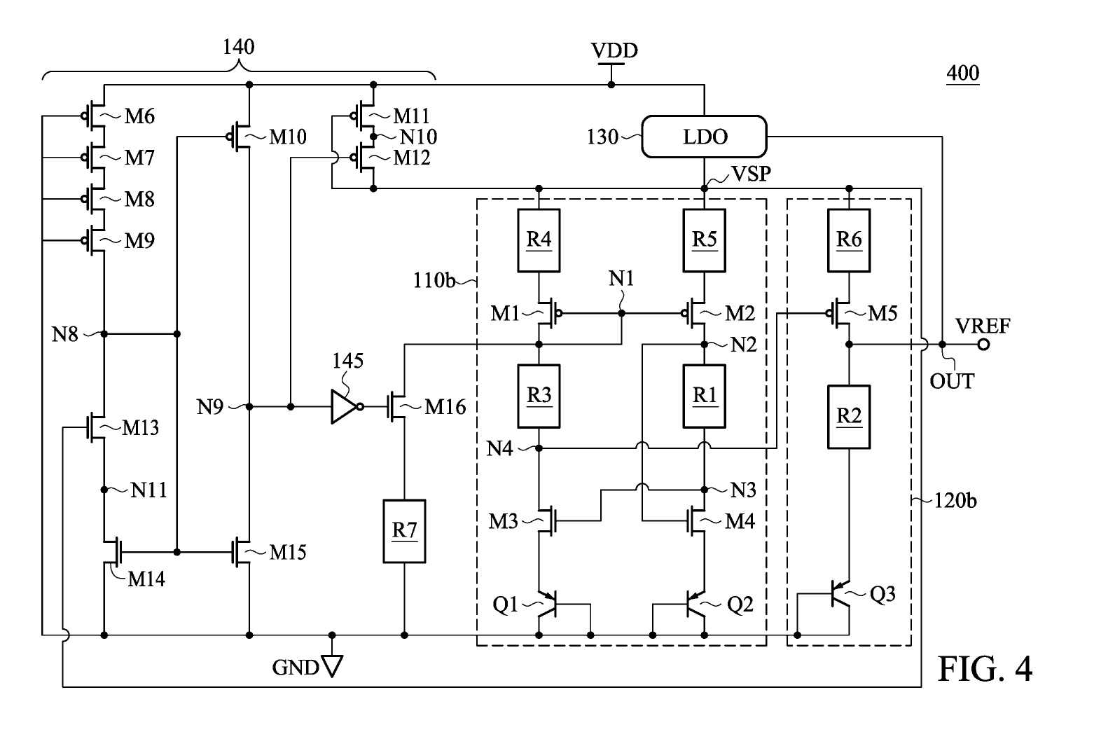

FIG. 4 is a circuit diagram for illustrating a bandgap circuit 400 according to another embodiment of the invention. The bandgap circuit 400 as shown in FIG. 4 is similar to the bandgap circuit 200 as shown in FIG. 2, wherein the core circuit 110a and the output branch 120a are replaced with a core circuit 110b and an output branch 120b, respectively. The only difference is that a resistor R3 is incorporated, and the gate of the transistor M5 is coupled to a node N4, not the node N1. The resistor R3 is coupled between the node N1 and the node N4. The node N4 is coupled to the transistor M3 and coupled to the gate of the transistor M5.

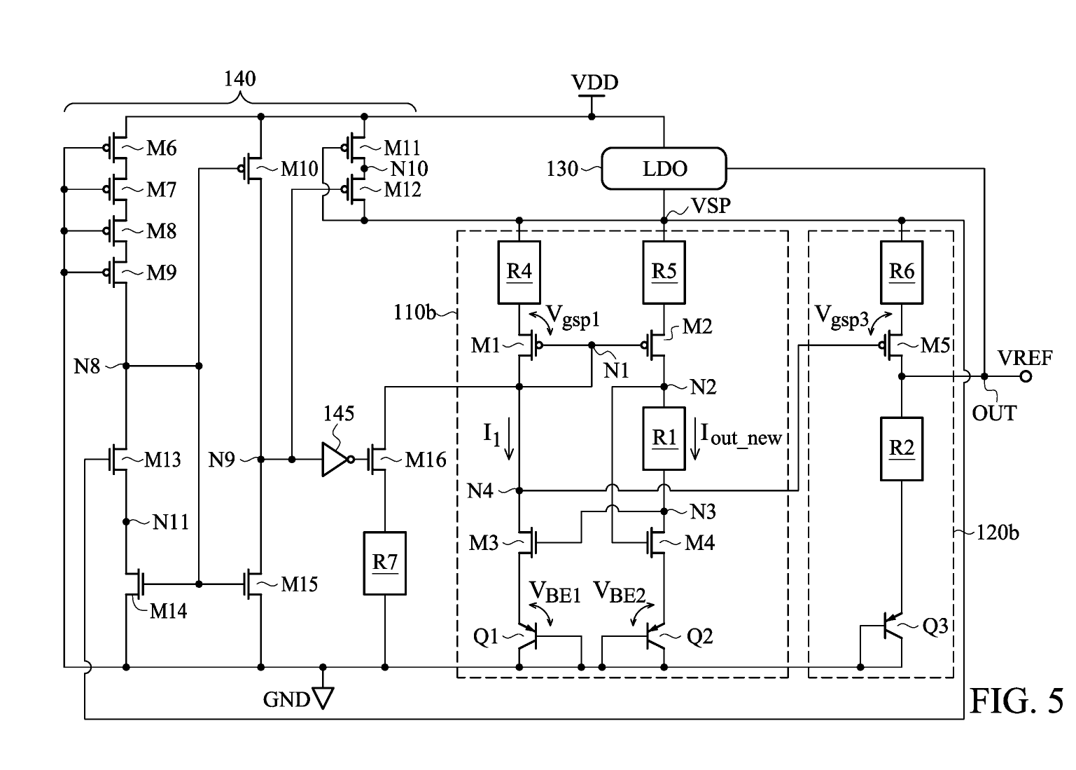

FIG. 5 is a circuit diagram for DC (Direct Current) analysis of the bandgap circuit 400 according to an embodiment of the invention. With the resistor R3, a current Iₒᵤₜ_{_{—}}_{new} out new flowing through the transistors M2 and M4 is analyzed as follows:

$$\begin{matrix}{V}_{gsp 1} = \sqrt{\frac{2 I}{{μ}_{p} {{C}_{ox} ( \frac{W}{L} )}_{p 1}}} + \vert {V}_{thp 1} \vert = {V}_{gsp 3} - {I}_{1} {R}_{3} & ( 26 ) \\ {V}_{gsp 3} = \sqrt{\frac{2 I}{{μ}_{p} {{C}_{ox} ( \frac{W}{L} )}_{p 1}}} + \vert {V}_{thp 1} \vert + {I}_{1} {R}_{3} & ( 27 ) \\ {I}_{out\_new} = \frac{1}{2} {μ}_{p} {{C}_{ox} ( \frac{W}{L} )}_{p 3} {( {V}_{gsp 3} - \vert {V}_{thp 3} \vert )}^{2} \\ ( assume {( \frac{W}{L} )}_{p 3} = \frac{1}{2} {( \frac{W}{L} )}_{p 1} , \vert {V}_{thp 1} \vert = \vert {V}_{thp 3} \vert , and {R}_{1} = {R}_{3} = R ) & ( 28 ) \\ IR \approx ( Δ {V}_{BE} + Δ {V}_{thn} ) + ( 1 - \sqrt{\frac{1}{N}} ) \sqrt{\frac{2 ( Δ {V}_{BE} + Δ {V}_{thn} )}{{μ}_{n} {{C}_{ox} ( \frac{W}{L} )}_{n 2} R}} & ( 29 )\end{matrix}$$

(It is noted that resistance variation ΔR will merely cause IR changing slightly)

$$\begin{matrix}{I}_{out\_new} = \frac{1}{4} {μ}_{p} {{C}_{ox} ( \frac{W}{L} )}_{p 1} {( {V}_{gsp 1} + {I}_{1} R - \vert {V}_{thp 1} \vert )}^{2} & ( 30 ) \\ {I}_{out\_new}^{′} \approx \frac{1}{4} {μ}_{p} {{C}_{ox} ( \frac{W}{L} )}_{p 1} {( {V}_{gsp 1} + Δ {V}_{gsp 1} + {I}_{1} R - \vert {V}_{thp 1} \vert )}^{2} & ( 31 ) \\ Δ {I}_{out\_new} \approx \frac{1}{4} {μ}_{p} {{C}_{ox} ( \frac{W}{L} )}_{p 1} ( 2 {V}_{gsp 1} + Δ {V}_{gsp 1} + 2 {I}_{1} R - 2 \vert {V}_{thp 1} \vert ) Δ {V}_{gsp 1} & ( 32 )\end{matrix}$$

wherein:

V_{gsp1} is the voltage difference between the gate and the source of the transistor M1;

V_{gsp3} is the voltage difference between the gate and the source of the transistor M5;

μₚ is electron mobility in PMOS transistors;

Cₒₓ is the capacitance per unit gate area of the oxide layer;

Vₜₕₙ₁ is the threshold voltage of the transistor M3;

Vₜₕₙ₂ is the threshold voltage of the transistor M4;

ΔVₜₕₙ is the difference between Vₜₕₙ₁ and Vₜₕₙ₂;

V_{BE1} is the voltage difference between the base and emitter of the BJT Q1;

V_{BE2} is the voltage difference between the base and emitter of the BJT Q2;

ΔV_{BE} is the difference between V_{BE1} and V_{BE2};

Vₜₕₚ₁ is the threshold voltage of the transistor M1;

Vₜₕₚ₃ is the threshold voltage of the transistor M5;

$${( \frac{W}{L} )}_{p 1}$$

is the ratio of channel width to channel length of the transistor M1;

$${( \frac{W}{L} )}_{n 2}$$

is the ratio of channel width to channel length of the transistor M4;

$${( \frac{W}{L} )}_{p 3}$$

is the ratio of channel width to channel length of the transistor M5;

R₁ is resistance of the resistor R1;

R₃ is resistance of the resistor R3;

I₁ is the direct current flowing through the transistor M1 and M3;

N is the size ratio of the transistor M3 to the transistor M4;

ΔV_{gsp1} is variation of the voltage difference between the gate and the source of the transistor M1;

I′ₒᵤₜ_{_{—}}_{new} is a corrected current flowing through the transistors M2 and M4 on account of ΔV_{gsp1}; and

ΔIₒᵤₜ_{_{—}}_{new} is the difference between Iₒᵤₜ_{_{—}}_{new} and I′ₒᵤₜ_{_{—}}_{new}.

For comparison, without the resistor R3, an original current Iₒᵤₜ_{_{—}}ₙₒᵣₘₐₗ flowing through the transistors M2 and M4 would be analyzed as follows:

$$\begin{matrix}{I}_{out\_normal} = \frac{1}{2} {μ}_{p} {{C}_{ox} ( \frac{W}{L} )}_{p 1} {( {V}_{gsp 1} - \vert {V}_{thp 1} \vert )}^{2} & ( 33 ) \\ {I}_{out\_normal}^{′} = \frac{1}{2} {μ}_{p} {{C}_{ox} ( \frac{W}{L} )}_{p 1} {( {V}_{gsp 1} + {V}_{gsp 1} - \vert {V}_{thp 1} \vert )}^{2} & ( 34 ) \\ Δ {I}_{out\_normal} = \frac{1}{2} {μ}_{p} {{C}_{ox} ( \frac{W}{L} )}_{p 1} ( 2 {V}_{gsp 1} + Δ {V}_{gsp 1} - 2 \vert {V}_{thp 1} \vert ) Δ {V}_{gsp 1} , & ( 35 )\end{matrix}$$

wherein:

ΔV_{gsp1} is variation of the voltage difference between the gate and the source of the transistor M1;

I′ₒᵤₜ_{_{—}}ₙₒᵣₘₐₗ is a current flowing through the transistors M2 and M4 on account of ΔV_{gsp1}; and

ΔIₒᵤₜ_{_{—}}ₙₒᵣₘₐₗ is the difference between Iₒᵤₜ_{_{—}}ₙₒᵣₘₐₗ and I′ₒᵤₜ_{_{—}}ₙₒᵣₘₐₗ.

The resistance of each resistor varies because of different process. That results in the variation ΔV_{gsp1}, and then results in the current variations ΔIₒᵤₜ_{_{—}}_{new} and ΔIₒᵤₜ_{_{—}}ₙₒᵣₘₐₗ. With the resistor R3, the current variation ΔIₒᵤₜ_{_{—}}_{new} in the bandgap circuit 400 will be smaller than the original current variation ΔIₒᵤₜ_{_{—}}ₙₒᵣₘₐₗ. The comparison between ΔIₒᵤₜ_{_{—}}_{new} and ΔIₒᵤₜ_{_{—}}ₙₒᵣₘₐₗ is expressed as follows:

$$\begin{matrix}\frac{Δ {I}_{out\_normal}}{Δ {I}_{out\_new}} \approx \frac{2 ( 2 {V}_{gsp 1} + Δ {V}_{gsp 1} - 2 \vert {V}_{thp 1} \vert )}{( 2 {V}_{gsp 1} + Δ {V}_{gsp 1} + 2 {I}_{1} R - 2 \vert {V}_{thp 1} \vert )} \approx \frac{2 ( 2 {V}_{dsatp 1} + Δ {V}_{gsp 1} )}{( 2 {V}_{dsatp 1} + Δ {V}_{gsp 1} + 2 {I}_{1} R )} \approx \frac{X}{Y} & ( 36 ) \\ X - Y \approx 2 {V}_{dsatp 1} + Δ {V}_{gsp 1} - 2 {I}_{1} R , & ( 37 )\end{matrix}$$

wherein:

V_{dsatp1} is a saturation voltage at the drain of the transistor M1.

In accordance with the equations (36)-(37), it is clear that the current variation ΔI_{out new} is smaller than the original current variation ΔI_{out normal} because the parameter (X-Y) is greater than 0. Therefore, the bandgap circuit 400 with the resistor R3 can effectively reduce VBG (Bandgap Output Voltage) variation, which results from variation of resistors across process.

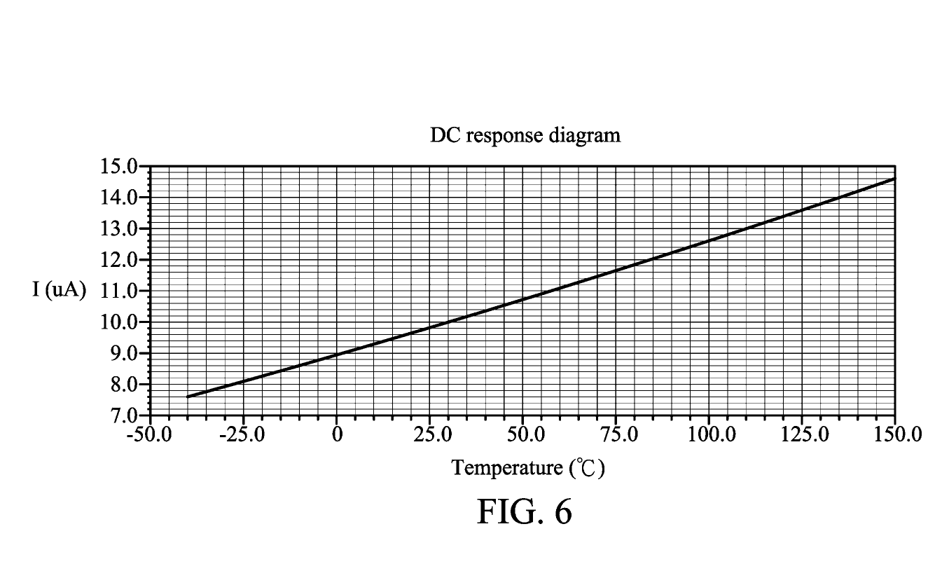

FIG. 6 is a DC (Direct Current) response diagram of the bandgap circuit 400 according to an embodiment of the invention. As shown in FIG. 6, the vertical axis represents the current I (i.e., Iₒᵤₜ_{_{—}}_{new} flowing through the transistors M2 and M4 in FIG. 5), and the horizontal axis represents temperature. The magnitude of the current I increases when the temperature increases. However, the relationship between the current I and the temperature is not linear. This is illustrated as follows.

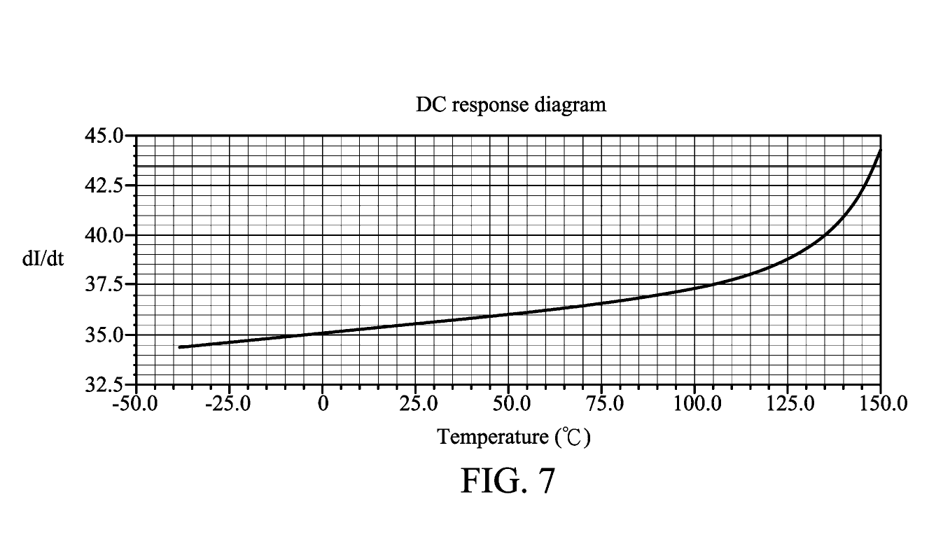

FIG. 7 is another DC response diagram of the bandgap circuit 400 according to the embodiment of the invention. As shown in FIG. 7, the vertical axis represents first order derivative of the current I (i.e., dI/dT, wherein T represents temperature), and the horizontal axis represents temperature. Since the curve in FIG. 7 is not a horizontal line, the relationship between the current I and the temperature is nonlinear. This is a significant feature in the invention.

In preferred embodiments of the invention, the bandgap circuits 100, 200 and 400 with a noise cancellation technique are designed to provide stable reference voltages without increasing an area thereof. The bandgap circuits have high PSRR (Power Supply Rejection Ratio) and ultra low noise. They can be applied to circuit blocks, such as a V to I (Voltage to Current) generator. Furthermore, the startup circuit 140 provides more robustness in the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A bandgap circuit for providing stable reference voltages, comprising:
a core circuit, comprising:
a first transistor, coupled between a supplied working voltage and a first node, and having a gate coupled to the first node;
a second transistor, coupled between the supplied working voltage and a second node, and having a gate coupled to the first node;
a third transistor, coupled between the first node and a ground voltage, and having a gate coupled to a third node;
a fourth transistor, coupled between the third node and the ground voltage, and having a gate coupled to the second node; and
a first resistor, coupled between the second and third nodes; and
an output branch, coupled to the core circuit to receive an output of the core circuit, and arranged to output a reference voltage at an output node.

2. The bandgap circuit as claimed in claim 1, further comprising:
a low dropout regulator, arranged to convert a power supply voltage into the supplied working voltage, wherein the reference voltage is fed to the low dropout regulator.

3. The bandgap circuit as claimed in claim 1, wherein the output branch comprises:
a fifth transistor, coupled between the output node and the supplied working voltage; and
a second resistor, coupled between the output node and the ground voltage.

4. The bandgap circuit as claimed in claim 3, wherein the fifth transistor has a gate coupled to the first node.

5. The bandgap circuit as claimed in claim 3, wherein the core circuit further comprises:
a third resistor, coupled between the first node and a fourth node, wherein the fourth node is coupled to the third transistor and coupled to a gate of the fifth transistor.

6. The bandgap circuit as claimed in claim 3, wherein the first, second and fifth transistors are PMOS transistors, and the third and fourth transistors are NMOS transistors.

7. The bandgap circuit as claimed in claim 1, further comprising a BJT (bipolar junction transistor) component coupled to the third and fourth transistors.

8. The bandgap circuit as claimed in claim 7, wherein the BJT component comprises:
a first BJT, coupled between the third transistor and the ground voltage, and having a base coupled to the ground voltage; and
a second BJT, coupled between the fourth transistor and the ground voltage, and having a base coupled to the ground voltage.

9. The bandgap circuit as claimed in claim 8, wherein a first size ratio of the third transistor to the fourth transistor is different from a second size ratio of the first BJT to the second BJT.

10. The bandgap circuit as claimed in claim 1, wherein the core circuit further comprises:
a fourth resistor, coupled between the first transistor and the supplied working voltage, and
a fifth resistor, coupled between the second transistor and the supplied working voltage.

11. The bandgap circuit as claimed in claim 3, wherein the output branch further comprises:
a third BJT, coupled between the second resistor and the ground voltage, and having a base coupled to the ground voltage.

12. The bandgap circuit as claimed in claim 3, wherein the output branch further comprises:
a sixth resistor, coupled between the fifth transistor and the supplied working voltage.
